(19) United States
(12) Patent Application Publication
(10) Pub. No.: US 2024/0399518 A1
(43) Pub. Date: Dec. 5, 2024

(54) Automated Conveying Apparatus

(71) Applicant: DMG MORI CO., LTD., Nara (JP)

(72) Inventors: Kenichi MIZUKOSHI, NARA (JP); Isao HIKITA, NARA (JP)

(73) Assignee: DMG MORI CO., LTD., Nara (JP)

(21) Appl. No.: 18/676,111

(22) Filed: May 28, 2024

(30) Foreign Application Priority Data
Jun. 5, 2023 (JP) 2023-092501
Jun. 5, 2023 (JP) 2023-92502
Oct. 18, 2023 (JP) 2023-179642

(51) Int. Cl. B23Q 3/155

(52) U.S. Cl. CPC B23Q 3/15534

(57) ABSTRACT

An automated conveying apparatus includes: a base unit; and a pivot supported by the base unit in a manner rotatable about a first axis. The pivot has a holding portion for detachably holding a conveyance object, and a turning mechanism which is configured to cause the holding portion to pivot about a turning center axis orthogonal to the first axis, the holding portion and the turning mechanism opposing each other in an axial direction of the turning center axis. The first axis is located at a position between the holding portion and the turning mechanism in the axial direction of the turning center axis, the position being closer to the holding portion than the turning mechanism.

### CROSS REFERENCE TO RELATED APPLICATIONS

This nonprovisional application is based on Japanese Patent Application No. 2023-092501 filed on Jun. 5, 2023, No. 2023-179642 filed on Oct. 18, 2023, and No. 2023-092502 filed on Jun. 5, 2023, with the Japan Patent Office, the entire content of which are hereby incorporated by reference.

### BACKGROUND OF THE INVENTION

### Field of the Invention

The present invention relates to an automated conveying apparatus.

### Description of the Background Art

For example, Japanese Patent Laying-Open No. 2022-20366 discloses a machine tool which includes: a tool rest turnable about the turning center axis; a first tool holder which is mounted on the tool rest and into which a tool is inserted in the axial direction of the turning center axis; a second tool holder which is mounted on the tool rest and into which a tool is inserted in the radial direction of the turning center axis; and an automatic tool changer.

The automatic tool changer has a gripping member that can grip the tool, and a cam mechanism that changes the posture of the gripping member between a posture in which the gripping member can grip the tool held by the first tool holder and a posture in which the gripping member can hold the tool held by the second tool holder.

### SUMMARY OF THE INVENTION

The machine tool disclosed in Japanese Patent Laying-Open No. 2022-20366 described above uses the cam mechanism to change the posture of a holding portion for holding a tool by 90 degrees, thereby implementing exchange of tools that are held in the first tool holder and exchange of tools that are held in the second tool holder.

In contrast, some machine tools include a first headstock and a second headstock on opposite sides of a tool rest, as headstocks for rotating workpieces. Such a machine tool requires the posture of a holding portion to be moved between: a first posture in which the direction of insertion of a tool and the radial direction of the turning center axis of the tool rest are parallel to each other; a second posture which is shifted by positive 90 degrees from the first posture and in which the direction of insertion of the tool and the turning center axis of the tool rest are parallel to each other; and a third posture which is shifted by negative 90 degrees from the first posture and in which the direction of insertion of the tool and the turning center axis of the tool rest are parallel to each other.

Thus, an object of the present invention is to provide an automated conveying apparatus that is in a compact configuration and capable of rotating a holding portion in a wider range.

An automated conveying apparatus according to one aspect of the present invention includes: a base unit; and a pivot supported by the base unit in a manner rotatable about a first axis. The pivot has: a holding portion for detachably holding a conveyance object; and a turning mechanism configured to cause the holding portion to turn about a turning center axis orthogonal to the first axis, the holding portion and the turning mechanism opposing each other in an axial direction of the turning center axis. The first axis is at a position between the holding portion and the turning mechanism in the axial direction of the turning center axis, the position being closer to the holding portion than the turning mechanism.

An automated conveying apparatus according to another aspect of the present invention includes: a holding portion for detachably holding a conveyance object; a pivot on which the holding portion is mounted and which is supported in a manner rotatable about a first axis extending in a first direction; a first axial member connected to the pivot and axially extending about a second axis extending in the first direction; a second axial member connected to the pivot, and axially extending about a third axis extending in the first direction, the first axial member and second axial member being arranged around the same circumference about the first axis; a first block which has a first cutout provided in a manner that enables the first axial member to advance and retreat with a pivotal motion of the pivot about the first axis; a first actuator connected to the first block and for causing the first block to slide between a first position and a second position away from the first position in a second direction orthogonal to the first direction; a second block which has a second cutout provided in a manner that enables the second axial member to advance and retreat with a pivotal motion of the pivot about the first axis; and a second actuator which is connected to the second block and causes the second block to slide between a third position and a fourth position away from the third position in a the third direction orthogonal to the first direction. As the first block is positioned at the first position and the second block is positioned at the third position, the first axial member is placed on the first cutout, the second axial member is placed on the second cutout, and the pivot is placed at a first phase position about the first axis. When the first block slides from the first position to the second position while the second block is kept positioned at the third position, the first block pushes the first axial member on the first cutout in a positive circumference direction about the first axis, and the second axial member leaves out of the second cutout, thereby causing the pivot to pivot from the first phase position toward a second phase position which is shifted from the first phase position in the positive circumference direction about the first axis. When the second block slides from the third position to the fourth position, while the first block is kept at the first position, the second block pushes the second axial member on the second cutout in a negative circumference direction about the first axis, and the first axial member leaves out of the first cutout, thereby causing the pivot to pivot from the first phase position toward a third phase position which is shifted from the first phase position in the negative circumference direction about the first axis.

An automated conveying apparatus according to still another aspect of the present invention includes: a holding portion for detachably holding a conveyance object; a pivot on which the holding portion is mounted and which is supported in a manner rotatable about a first axis extending in a first direction; a first axial member and a second axial member which are connected to the pivot and axially extending respectively about a second axis and a third axis extending in the first direction; a first block which has a first cutout provided in a manner that enables the first axial member to advance and retreat with a pivotal motion of the pivot about the first axis; a first actuator which is connected to the first block and causes the first block to slide in a second direction orthogonal to the first direction; a second block which has a second cutout provided in a manner that enables the second axial member to advance and retreat with a pivotal motion of the pivot about the first axis; and a second actuator which is connected to the second block and causes the second block to slide in a third direction orthogonal to the first direction. When the first actuator causes the first block to slide in the second direction, the first block pushes the first axial member on the first cutout in a circumference direction of the first axis and the second axial member leaves out of the second cutout. When the second actuator causes the second block to slide in the third direction, the second block pushes the second axial member on the second cutout in the circumference direction of the first axis, and the first axial member leaves out of the first cutout.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a machine tool which includes an automated conveying apparatus according to Embodiment 1 of the present invention.

FIG. 2 is a top view showing an aspect of a tool change process for a tool rest of FIG. 1.

FIG. 3 is a top view showing another aspect of the tool change process for the tool rest of FIG. 1.

FIG. 4 is a top view showing still another aspect of the tool change process for the tool rest of FIG. 1.

FIG. 5 is a perspective view of the automated conveying apparatus (a first posture) of FIG. 1.

FIG. 6 is another perspective view of the automated conveying apparatus (the first posture) of FIG. 1.

FIG. 7 is an exploded view of the automated conveying apparatus (the first posture) of FIG. 6.

FIG. 8 is a perspective view of a base unit of FIG. 7.

FIG. 9 is a cross-sectional view of the automated conveying apparatus (the first posture) as viewed in the direction of arrow on IX-IX line of FIG. 5.

FIG. 10 is a cross-sectional view of the automated conveying apparatus moving from a first posture toward a second posture.

FIG. 11 is a cross-sectional view of the automated conveying apparatus in the second posture.

FIG. 12 is a cross-sectional view of the automated conveying apparatus moving from the first posture toward a third posture.

FIG. 13 is a cross-sectional view of the automated conveying apparatus in the third posture.

FIG. 14 is a side view showing an aspect of a piston cylinder during an extension motion in the automated conveying apparatus of FIGS. 5 and 6.

FIG. 15 is a side view showing an aspect of the piston cylinder during a retraction motion in the automated conveying apparatus of FIGS. 5 and 6.

FIG. 16 is a cross-sectional view of the automated conveying apparatus of FIGS. 5 and 6.

### DESCRIPTION OF THE PREFERRED EMBODIMENTS

An embodiment according to the present invention will be described, with reference to the accompanying drawings. Referring now to the drawings wherein like numerals are used to refer to like or corresponding members.

### Embodiment 1

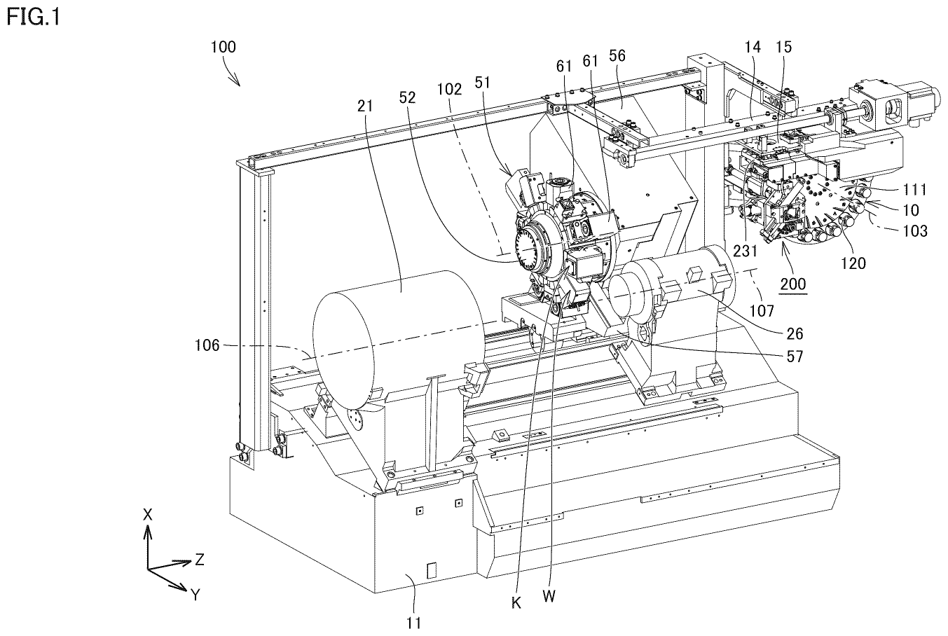

FIG. 1 is a perspective view of a machine tool which includes an automated conveying apparatus according to Embodiment 1 of the present invention. In the figure, an internal structure of a machine tool, as seen through a cover body forming the appearance of the machine tool, is shown.

Referring to FIG. 1, a machine tool 100 is a lathe which performs workpiece processing by bringing a tool into contact with a rotating workpiece. The machine tool 100 is equipped with milling capabilities for processing a workpiece by bringing a rotating tool into contact with the workpiece that is stationary.

The machine tool 100 is a numerically controlled (NC) machine tool whose various operations for the workpiece processing are automated by a computerized numerical control.

As used herein, the axis that is parallel to the left-right direction (the width direction) of the machine tool 100 and extends in the horizontal direction will be referred to as “Z axis,” the axis that is parallel to the front-rear direction (the depth direction) of the machine tool 100 and extends in the horizontal direction will be referred to as “Y axis,” and the axis extending in the vertical direction will be referred to as “X axis.” The right direction in FIG. 1 will be referred to as “positive Z-axis direction,” and the left direction will be referred to as “negative Z-axis direction.” The front direction relative to the plane of the drawing in FIG. 1 will be referred to as “positive Y-axis direction,” and the depth direction will be referred to as “negative Y-axis direction.” Positive Y-axis direction corresponds to the front of the machine, and negative Y-axis direction corresponds to the rear of the machine. The up direction in FIG. 1 will be referred to as “positive X-axis direction,” and the down direction will be referred to as “negative X-axis direction.”

While X axis, Y axis, and Z axis are set as described above for the purpose of illustration of the structures of the machine tool 100 and an automated conveying apparatus 200 included in the machine tool 100, it should be noted that these axes do not necessarily coincide with the X axis, Y axis, and Z axis that are defined by the lathe.

Initially, a structure of the machine tool 100 is described. The machine tool 100 has a bed 11, a first headstock 21, a second headstock 26, a tool rest 51, a magazine 10, and the automated conveying apparatus 200.

The bed 11 is a base member for supporting the first headstock 21, the second headstock 26, the tool rest 51, the magazine 10, and the automated conveying apparatus 200, etc., and is installed on the floor of a factory, for example. The bed 11 is formed of a metal such as cast iron.

The first headstock 21 and the second headstock 26 are mounted on the bed 11. The first headstock 21 and the second headstock 26 each have a workpiece spindle (not shown). A chuck for detachably holding a workpiece is provided at the tip of the workpiece spindle. The workpiece spindle of the first headstock 21 is rotationally driven about a central axis of rotation 106 that is parallel to Z axis. The workpiece spindle of the second headstock 26 is rotationally driven about a central axis of rotation 107 that is parallel to Z axis. The first headstock 21 and the second headstock 26 are arranged opposing each other in Z-axis direction so that the central axis of rotation 106 and the central axis of rotation 107 extend in line with each other.

The tool rest 51 is disposed within a processing area. The processing area is a space where the workpiece is processed, and is substantially sealed with a cover body to prevent any contaminations such as chips or cutting fluids involved in the workpiece processing from leaking out of the processing area. The tool rest 51 is configured to hold multiple tools. The tool rest 51 is a turret-type tool rest that is turnable about a turning center axis 102 parallel to Z axis.

The tool rest 51 has a turret 52, a tool rest base 56, and multiple tool holders 61. The tool rest base 56 is mounted on a cross slide (not shown).

The turret 52 projects from the tool rest base 56 in a direction (negative Z-axis direction) approaching the first headstock 21 in Z-axis direction. The turret 52 has a disc shape whose direction of thickness is the axial direction of the turning center axis 102. The turret 52 is turnable about the turning center axis 102.

The tool holders 61 are mounted on the turret 52. The tool holders 61 are connected to the turret 52, using bolts, etc. The tool holders 61 are aligned in the circumference direction of the turning center axis 102. The tool holder 61 detachably holds a tool. The tool holder 61 has a built-in clamping mechanism for clamping or unclamping a tool, and a rotation mechanism for rotating a tool.

As the turret 52 turns about the turning center axis 102, the tools held by the tool holders 61 move in the circumference direction of the turning center axis 102. To process a workpiece held in the workpiece spindle of the first headstock 21 or the second headstock 26, a tool holders 61 is positioned at a workpiece processing position W. To exchange tools with an automated conveying apparatus 200 described below, a tool holder 61 is positioned at a tool-rest side tool change position K.

The tool rest 51 is supported by the bed 11 via a saddle 57 and a cross slide (not shown). The saddle 57 is movable in Z-axis direction by various feeding mechanisms, guide mechanisms, and servomotors, etc. The cross slide is movable by various feeding mechanisms, guide mechanisms, and servomotors, etc. in an axial direction (referred to as Xa-axis direction”), which is orthogonal to Z axis and inclined relative to X axis and Y axis. As the saddle 57 and the cross slide move in Z-axis direction and Xa-axis direction, respectively, the position for processing the workpiece by the tool held by the tool holder 61 can be moved in a Z-Xa axis plane.

The magazine 10 is disposed outside the processing area. The magazine 10 is disposed apart from the tool rest 51 in positive Z-axis direction. The tool rest 51 is arranged between the first headstock 21 and the magazine 10 in Z-axis direction.

Since the magazine 10 sequentially supplies tools to the processing area in accordance with processing purposes, the magazine 10 is a device storing multiple tools. The magazine 10 stores rotary tools such as drills, end mills, or milling cutters, or fastening tools such as outer diameter cutting tools, inner diameter cutting tools, or grooving tools, which are to be mounted on the tool holders 61 at the tool rest 51.

The magazine 10 has a support plate 111, multiple tool pots 120, and a motor (not shown). The support plate 111 has a disc shape about a turning center axis 103 parallel to Y axis. The tool pots 120 are mounted on the support plate 111. The tool pots 120 are aligned at regular intervals along a circumferential path about the turning center axis 103.

The support plate 111 is turnable by a motor (not shown) about the turning center axis 103 in the positive circumference direction and the negative circumference direction. The support plate 111 turns about the turning center axis 103, thereby conveying the tool pots 120 in the circumference direction of the turning center axis 103. A tool pot 120 is arranged at a magazine-side tool change position for exchange of tools with an automatic tool changer 31 described below.

The automated conveying apparatus 200 is an apparatus for conveying tools as conveyance objects. The automated conveying apparatus 200 is supported by a support frame 14. The support frame 14 extends in Z-axis direction above the second headstock 26.

The automated conveying apparatus 200 has a first base 15 and a second base 231. The first base 15 is movable in Z-axis direction relative to the support frame 14 by various feeding mechanisms, guide mechanisms, and servomotors, etc. The second base 231 is movable in Y-axis direction relative to the first base 15 by various feeding mechanisms, guide mechanisms, and servomotors, etc. With such a configuration, the automated conveying apparatus 200 is configured to move in Y-axis direction and Z-axis direction.

The automated conveying apparatus 200 moves in Z-axis direction, thereby conveying tools between the tool rest 51 in the processing area and the magazine 10 outside the processing area. A shutter (not shown) capable of closing and opening operation is disposed between the tool rest 51 and the magazine 10. The shutter has a plate shape parallel to an X-Y axis plane.

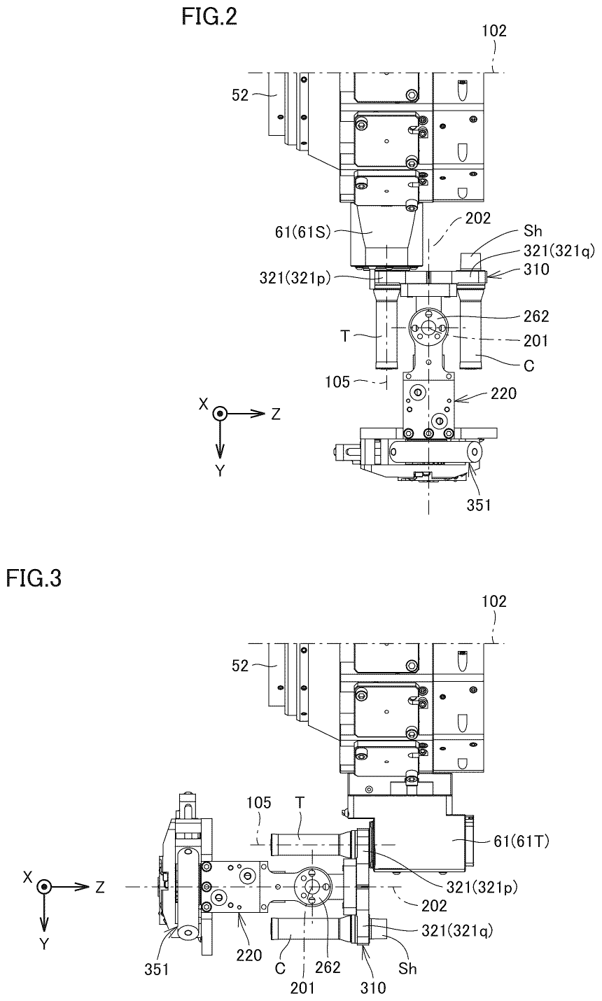

FIGS. 2, 3, and 4 are top views each showing an aspect of a tool change process on the tool rest of FIG. 1. Referring to FIGS. 1 through 4, the automated conveying apparatus 200 has a tool change unit 310. The tool change unit 310 changes the tool in a tool holder 61 positioned at the tool-rest side tool change position K on the tool rest 51, and changes the tool in a tool pot 120 that is positioned at the magazine-side tool change position in the magazine 10.

The tool change unit 310 has a holding portion 321 and a turning mechanism 351. The holding portion 321 detachably holds a tool T. The holding portion 321 has a claw shape which allows gripping of a tool. The tool change unit 310 has a pair of holding portions 321p and 321q as the holding portion 321 and is of a double-arm type that can hold two tools T at a time. The tool change unit 310 may be of a single-arm type that can hold one tool T at a time.

The turning mechanism 351 is configured to cause the holding portion 321 to turn about a turning center axis 202. The turning center axis 202 is parallel to a tool central axis 105 of the tool T held by the holding portion 321.

The tool holders 61 include a first tool holder 61S, a second tool holder 61T, and a third tool holder 61U.

As shown in FIG. 2, the tool central axis 105 of the tool T held by the first tool holder 61S extends in the radial direction (Y-axis direction) of the turning center axis 102 of the turret 52. The tool T held by the first tool holder 61S can be used to process the workpieces held by the first headstock 21 and the second headstock 26. To mount the tool T held by the tool change unit 310 onto the first tool holder 61S, the holding portion 321 is positioned to oppose the first tool holder 61S in the radial direction (Y-axis direction) of the turning center axis 102. The tool T held by the holding portion 321 is slid into the first tool holder 61S in the radial direction (negative Y-axis direction) of the turning center axis 102.

As shown in FIG. 3, the tool central axis 105 of the tool T held by the second tool holder 61T extends in Z-axis direction, and that tool T projects from the second tool holder 61T in negative Z-axis direction. The tool T held by the second tool holder 61T can be used to, primarily, process the workpiece held by the first headstock 21. To mount the tool T held by the tool change unit 310 onto the second tool holder 61T, the holding portion 321 is positioned to oppose the second tool holder 61T from the negative side of Z axis in the axial direction of the turning center axis 102. The tool T held by the holding portion 321 is slid into the second tool holder 61T in the axial direction (positive Z-axis direction) of the turning center axis 102.

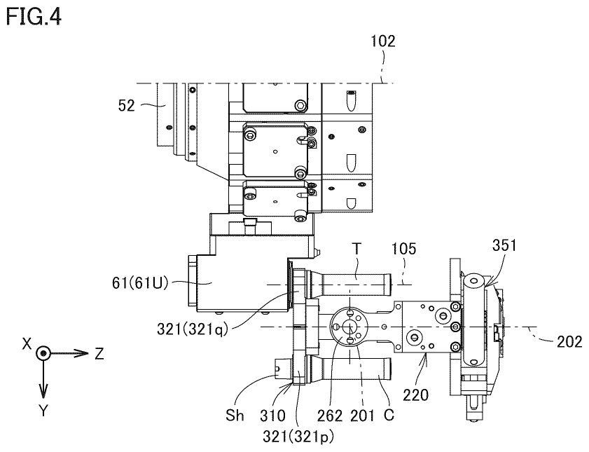

As shown in FIG. 4, the tool central axis 105 of the tool T held by the third tool holder 61U extends in Z-axis direction, and that tool T projects from the third tool holder 61U in positive Z-axis direction. The tool T held by the third tool holder 61U can be used to process, primarily, the workpiece held by the second headstock 26. To mount the tool T held by the tool change unit 310 onto the third tool holder 61U, the holding portion 321 is positioned to oppose the third tool holder 61U in the axial direction of the turning center axis 102 from the positive side of Z axis. The tool T held by the holding portion 321 is slid into the third tool holder 61U in the axial direction (negative Z-axis direction) of the turning center axis 102.

To enable the tool change of the first tool holder 61S, the second tool holder 61T, and the third tool holder 61U described above, the automated conveying apparatus 200 is equipped with a mechanism for causing the tool change unit 310 (the holding portion 321) to pivot between a first posture (the posture shown in FIG. 2), a second posture (the posture shown in FIG. 3) shifted by positive 90 degrees from the first posture, and a third posture (the posture shown in FIG. 4) shifted by negative 90 degrees from the first posture. In the following, the pivot mechanism is described in detail.

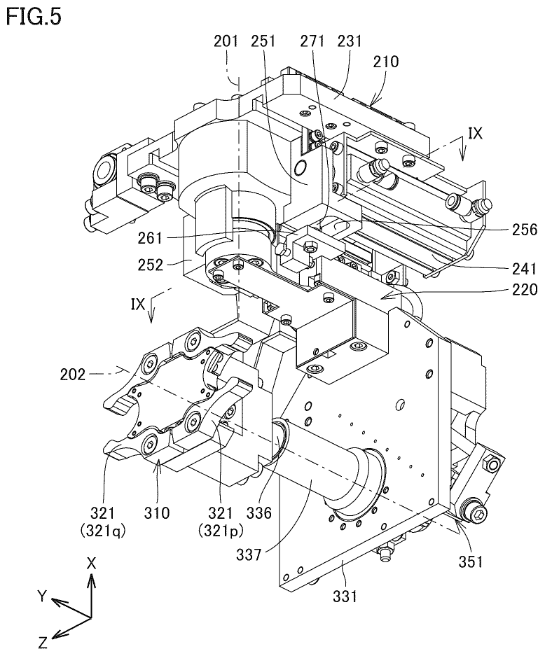

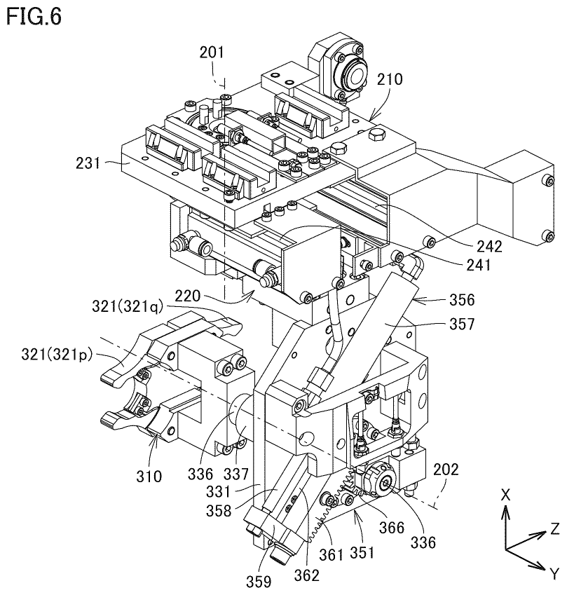

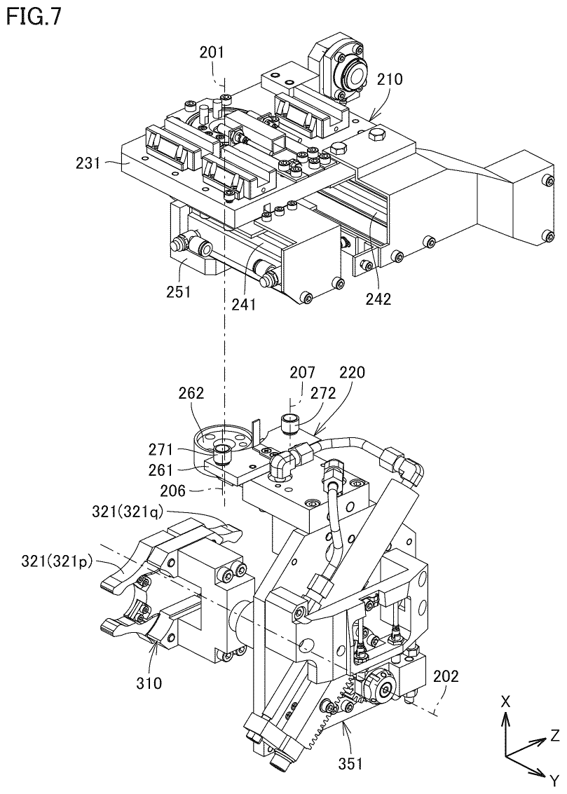

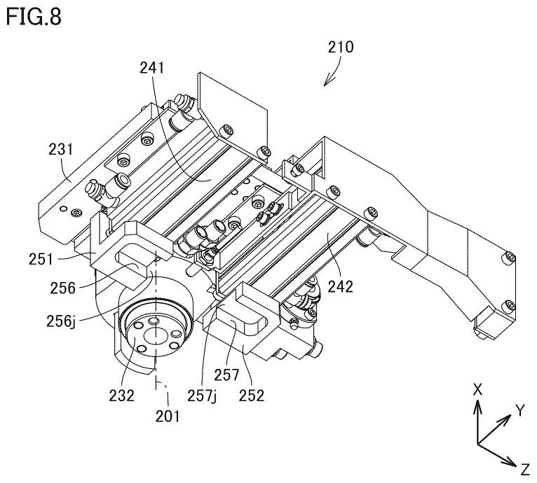

FIGS. 5 and 6 are perspective views each showing the automated conveying apparatus (the first posture) of FIG. 1. FIG. 7 is an exploded view of the automated conveying apparatus (the first posture) of FIG. 6. FIG. 8 is a perspective view of the base unit of FIG. 7.

Referring to FIGS. 5 through 8, the automated conveying apparatus 200 further has a base unit 210. The base unit 210 is connected to the support frame 14 via the first base 15 of FIG. 1.

The base unit 210 has a second base 231. The second base 231 is formed of a plate member disposed in parallel to a Y-Z axis plane.

The automated conveying apparatus 200 further has a pivot 220. The pivot 220 is arranged below the base unit 210. The pivot 220 is supported by the base unit 210 in a manner rotatable about a first axis 201. The first axis 201 extends in X-axis direction (the vertical direction). An extension of the first axis 201 extending in negative X-axis direction intersects with the turning center axis 202.

More specifically, the base unit 210 further has a coupling 232, as shown in FIG. 8. The coupling 232 is disposed in a manner rotatable about the first axis 201 relative to the second base 231. As shown in FIG. 7, the pivot 220 has a coupling 262. The coupling 262 and the coupling 232 oppose each other in the axial direction of the first axis 201. The coupling 262 is coupled to the coupling 232.

A tool change unit 310 (the holding portion 321) is mounted on the pivot 220. The pivot 220 is arranged between the base unit 210 and the tool change unit 310 in X-axis direction. The tool change unit 310 (the holding portion 321) pivots in unison with the pivot 220 with the pivotal motion of the pivot 220 about the first axis 201.

The pivot 220 further has a plate 261. The plate 261 is formed of a plate member disposed in parallel to the Y-Z axis plane. The plate 261 is disposed radially outwardly of the first axis 201, away from the coupling 262.

The automated conveying apparatus 200 further has a first axial member 271 and a second axial member 272. The first axial member 271 and the second axial member 272 are connected to the pivot 220. The first axial member 271 and the second axial member 272 are connected to the plate 261.

The first axial member 271 axially extends about a second axis 206. The second axial member 272 axially extends about a third axis 207. The second axis 206 and the third axis 207 extend in parallel to each other. The second axis 206 and the third axis 207 each extend in X-axis direction. The first axial member 271 and the second axial member 272 project from the plate 261 in positive X-axis direction.

The first axial member 271 and the second axial member 272 are arranged around the same circumference about the first axis 201. In other words, the distance between the first axis 201 and the second axis 206 is the same as the distance between the first axis 201 and the third axis 207.

The first axial member 271 and the second axial member 272 are cam followers that are rotatable about the second axis 206 and the third axis 207, respectively. The first axial member 271 is supported by the plate 261 in a manner rotatable about the second axis 206. The second axial member 272 is supported by the plate 261 in a manner rotatable about the third axis 207.

The automated conveying apparatus 200 further has a first block 251, a second block 252, a first actuator 241, and a second actuator 242. The first block 251, the second block 252, the first actuator 241, and the second actuator 242 are mounted on the base unit 210.

The first actuator 241 and the second actuator 242 are mounted on the second base 231. The first actuator 241 and the second actuator 242 are arranged between the second base 231 and the pivot 220 in X-axis direction. The first actuator 241 and the second actuator 242 are disposed apart from each other in Z-axis direction. The first actuator 241 and the second actuator 242 are disposed symmetrically across an X-Z axis plane which includes the first axis 201. The first actuator 241 is disposed on the negative side of Z axis, relative to the X-Z axis plane which includes the first axis 201. The second actuator 242 is disposed on the positive side of Z axis, relative to the X-Z axis plane which includes the first axis 201.

The first actuator 241 and the second actuator 242 are formed of pneumatic piston cylinders. The first actuator 241 and the second actuator 242 extend in Y-axis direction. The first actuator 241 and the second actuator 242 output linear motions that are parallel to each other in Y-axis direction. The first actuator 241 and the second actuator 242 have the same stroke range in Y-axis direction.

The first block 251 and the second block 252 are connected to the first actuator 241 and the second actuator 242, respectively. The first block 251 is connected to a cylinder piston rod of the first actuator 241. The first block 251 slides in negative Y-axis direction with the extension motion of the first actuator 241, and slides in positive Y-axis direction with the retraction motion of the first actuator 241. The second block 252 is connected to a cylinder piston rod of the second actuator 242. The second block 252 slides in negative Y-axis direction with the extension motion of the second actuator 242, and slides in positive Y-axis direction with the retraction motion of the second actuator 242.

Note that the first actuator 241 and the second actuator 242 may be hydraulic piston cylinders or electrically-powered piston cylinders. The first actuator and the second actuator according to the present invention are not limited to piston cylinders and may be any actuators that can output the linear motions.

The first block 251 has a first cutout 256. The first cutout 256 has a notched shape receding into the bottom surface of the first block 251 facing in negative X-axis direction. The first cutout 256 has a first opening 256j. The first opening 256j opens in positive Z-axis direction.

The second block 252 has a second cutout 257. The second cutout 257 has a notched shape receding into the bottom surface of the second block 252 facing in negative X-axis direction. The second cutout 257 has a second opening 257j. The second opening 257j opens in negative Z-axis direction.

Note that the structure consisting of the base unit 210, and the first block 251, the second block 252, the first actuator 241, and the second actuator 242, which are mounted on the base unit 210, is symmetric across the X-Z axis plane which includes the first axis 201.

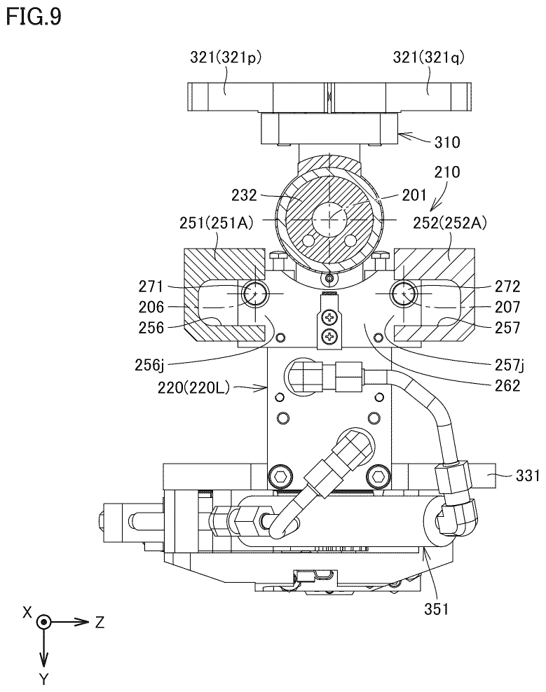

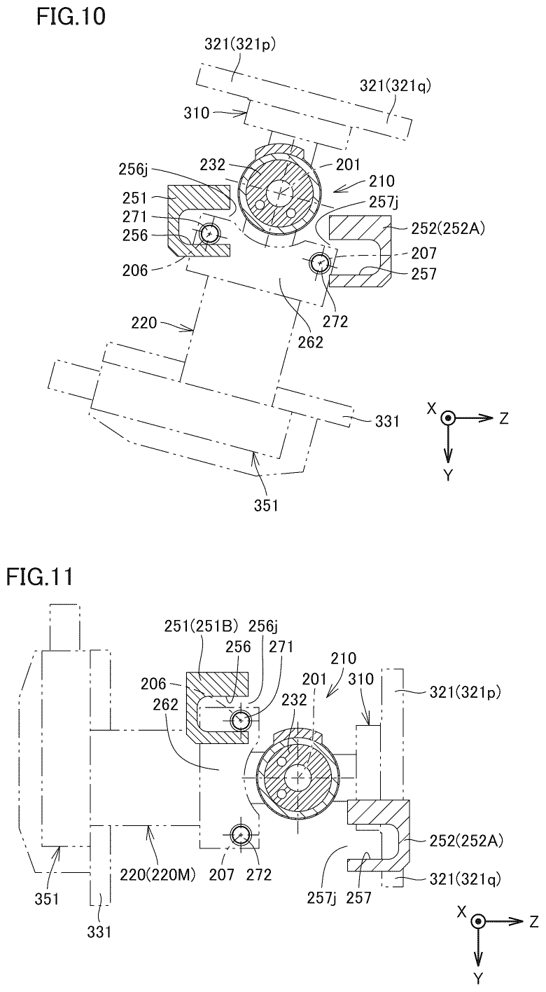

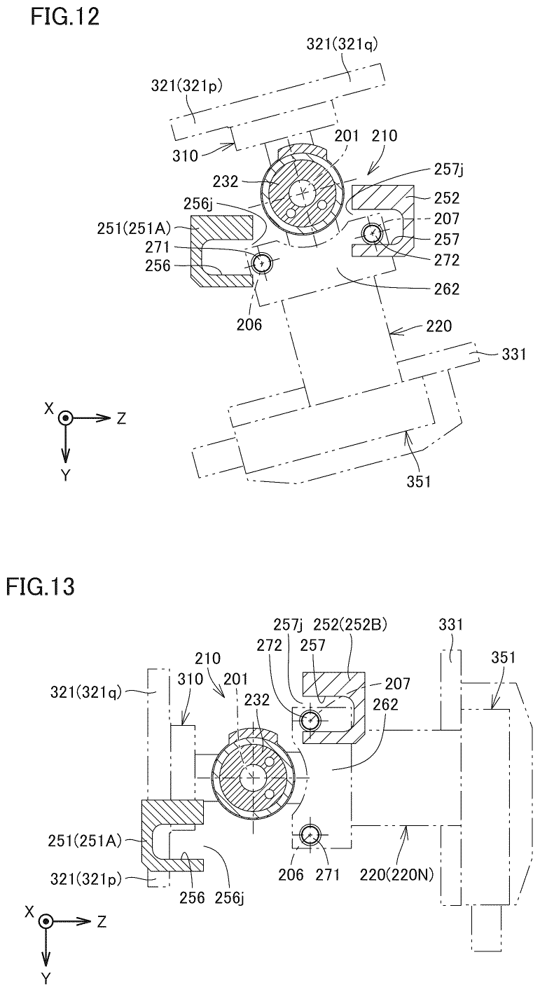

FIG. 9 is a cross-sectional view of the automated conveying apparatus (the first posture) as viewed in the direction of arrow on IX-IX line of FIG. 5. FIG. 10 is a cross-sectional view of the automated conveying apparatus moving from the first posture toward the second posture. FIG. 11 is a cross-sectional view of the automated conveying apparatus in the second posture. FIG. 12 is a cross-sectional view of the automated conveying apparatus moving from the first posture toward the third posture. FIG. 13 is a cross-sectional view of the automated conveying apparatus in the third posture.

Referring to FIGS. 9 through 13, the first cutout 256 is provided in a manner that enables the first axial member 271 to advance or retreat with the pivotal motion of the pivot 220 about the first axis 201. The first actuator 241 causes the first block 251 to slide between a first position 251A of FIG. 9 and a second position 251B of FIG. 11. The second position 251B is located away from the first position 251A in Y-axis direction (negative Y-axis direction) orthogonal to X-axis direction.

The second cutout 257 is provided in a manner that enables the second axial member 272 to advance and retreat with the pivotal motion of the pivot 220 about the first axis 201. The second actuator 242 causes the second block 252 to slide between a third position 252A of FIG. 9 and a fourth position 252B of FIG. 13. The fourth position 252B is located away from the third position 252A in Y-axis direction (negative Y-axis direction) orthogonal to X-axis direction.

As shown in FIGS. 5 through 9, the first block 251 is positioned at the first position 251A, and the second block 252 is positioned at the third position 252A when the tool change unit 310 (the holding portion 321) is in the first posture for changing the tool in the first tool holder 61S of FIG. 2. The first position 251A and the third position 252A oppose each other in Z-axis direction. The first position 251A and the third position 252A are located symmetrically across the X-Y axis plane that includes the first axis 201. The first opening 256j opens, facing the second block 252 in Z-axis direction. The second opening 257j opens, facing the first block 251 in Z-axis direction.

The first axial member 271 is arranged on the first cutout 256. The second axial member 272 is arranged on the second cutout 257. The first axial member 271 abuts the wall of the first cutout 256 on the negative side of Y axis. The second axial member 272 abuts the wall of the second cutout 257 on the negative side of Y axis. The first axial member 271 and the second axial member 272 are arranged symmetrically across the X-Y axis plane which includes the first axis 201.

The pivot 220 is arranged at a first phase position 220L about the first axis 201. The first axial member 271 and the second axial member 272 are arranged on the positive side of Y axis relative to the X-Z axis plane which includes the first axis 201. The holding portion 321 is arranged on the negative side of Y axis relative to the X-Z axis plane which includes the first axis 201.

As shown in FIG. 11, the first block 251 is positioned at the second position 251B and the second block 252 is positioned at the third position 252A when the tool change unit 310 (the holding portion 321) is in the second posture for changing the tool in the second tool holder 61T of FIG. 3. The second position 251B is located symmetrical with the first position 251A across the X-Z axis plane which includes the first axis 201. The second position 251B is located opposite the third position 252A across the first axis 201.

The first axial member 271 is arranged on the first cutout 256. The second axial member 272 is arranged outside the second cutout 257. The first axial member 271 abuts the wall of the first cutout 256 on the positive side of Y axis. The first axial member 271 and the second axial member 272 are arranged symmetrically across the X-Z axis plane which includes the first axis 201.

The pivot 220 is arranged at a second phase position 220M about the first axis 201. The second phase position 220M is shifted from the first phase position 220L in the positive circumference direction (clockwise as viewed from the top) about the first axis 201. The second phase position 220M is shifted from the first phase position 220L by positive 90 degrees about the first axis 201.

As shown in FIGS. 9 and 11, the first axial member 271 (the second axis 206) when the first block 251 is positioned at the first position 251A and the first axial member 271 (the second axis 206) when the first block 251 is positioned at the second position 251B are arranged co-linearly in Y-axis direction.

As shown in FIG. 13, the first block 251 is positioned at the first position 251A, and the second block 252 is positioned at the fourth position 252B when the tool change unit 310 (the holding portion 321) is at the third position for changing the tool in the third tool holder 61U of FIG. 4. The fourth position 252B is located symmetrical with the third position 252A across the X-Z axis plane which includes the first axis 201. The fourth position 252B is located opposite the first position 251A across the first axis 201. The second position 251B and the fourth position 252B oppose each other in Z-axis direction. The second position 251B and the fourth position 252B are located symmetrically across the X-Y axis plane which includes the first axis 201.

The first axial member 271 is arranged outside the first cutout 256. The second axial member 272 is arranged on the second cutout 257. The second axial member 272 abuts the wall of the second cutout 257 on the positive side of Y axis. The first axial member 271 and the second axial member 272 are arranged symmetrically across the X-Z axis plane which includes the first axis 201.

The pivot 220 is arranged at a third phase position 220N about the first axis 201. The third phase position 220N is shifted from the first phase position 220L in the negative circumference direction (anti-clockwise as viewed from the top) about the first axis 201. The third phase position 220N is shifted from the first phase position 220L by negative 90 degrees about the first axis 201.

As shown in FIGS. 9 and 13, the second axial member 272 (the third axis 207) when the second block 252 is positioned at the third position 252A and the second axial member 272 (the third axis 207) when the second block 252 is positioned at the fourth position 252B are arranged co-linearly in Y-axis direction.

Referring to FIGS. 9 through 11, to change the automated conveying apparatus 200 from the first posture to the second posture, the first actuator 241 of FIG. 8 is extended, thereby causing the first block 251 to slide from the first position 251A to the second position 251B, while the second block 252 is kept positioned at the third position 252A. In this case, the first block 251 pushes the first axial member 271 on the first cutout 256 in the positive circumference direction about the first axis 201, and the second axial member 272 leaves out of the second cutout 257.

When the first actuator 241 causes the first block 251 to slide in Y-axis direction, the first block 251 pushes the first axial member 271 on the first cutout 256 in the circumference direction of the first axis 201, and the second axial member 272 leaves out of the second cutout 257.

More specifically, the first block 251 slides from the first position 251A toward the second position 251B, while keeping the wall of the first cutout 256 on the positive side of Y axis in contact with the first axial member 271. The first axial member 271, while rotating about the second axis 206, receives a force in negative Y-axis direction from the first block 251. This allows the first axial member 271 and the second axial member 272 to move in an arc in the positive circumference direction about the first axis 201. The first axial member 271 is kept placed on the first cutout 256. The second axial member 272 leaves out of the second cutout 257 through the second opening 257j. The above steps cause the pivot 220 to pivot from the first phase position 220L toward the second phase position 220M.

Referring to FIGS. 9, 12, and 13, to change the automated conveying apparatus 200 from the first posture to the third posture, the second actuator 242 of FIG. 8 is extended, thereby causing the second block 252 to slide from the third position 252A to the fourth position 252B, while the first block 251 is kept positioned at the first position 251A. In this case, the second block 252 pushes the second axial member 272 on the second cutout 257 in the negative circumference direction about the first axis 201, and the first axial member 271 leaves out of the first cutout 256.

When the second actuator 242 causes the second block 252 to slide in Y-axis direction, the second block 252 pushes the second axial member 272 on the second cutout 257 in the circumference direction of the first axis 201, and the first axial member 271 leaves out of the first cutout 256.

More specifically, the second block 252 slides from the third position 252A toward the fourth position 252B, while keeping the wall of the second cutout 257 on the positive side of Y axis in contact with the second axial member 272. The second axial member 272, while rotating about the third axis 207, receives a force in negative Y-axis direction from the second block 252. This allows the first axial member 271 and the second axial member 272 to move in an arc in the negative circumference direction about the first axis 201. The second axial member 272 is kept placed on the second cutout 257. The first axial member 271 leaves out of the first cutout 256 through the first opening 256j. The above steps cause the pivot 220 to pivot from the first phase position 220L toward the third phase position 220N.

Note that the first actuator 241 of FIG. 8 may be retracted in order to change the automated conveying apparatus 200 from the second posture to the first posture, and the second actuator 242 of FIG. 8 may be retracted in order to change the automated conveying apparatus 200 from the third posture to the first posture.

In the present embodiment, when the first block 251 slides from the first position 251A to the second position 251B, while the second block 252 is kept positioned at the third position 252A, the first block 251 pushes the first axial member 271 on the first cutout 256 in the positive circumference direction about the first axis 201, thereby causing the pivot 220 to pivot from the first phase position 220L toward the second phase position 220M. In this case, the second axial member 272 connected to the pivot 220 leaves out of the second cutout 257 with the pivotal motion of the pivot 220. Thus, a range of motion available to the pivot 220 between the first phase position 220L and the second phase position 220M can be defined beyond a range of motion available to the second axial member 272 on the second cutout 257.

Similarly, when the second block 252 slides from the third position 252A to the fourth position 252B, while the first block 251 is kept positioned at the first position 251A, the second block 252 pushes the second axial member 272 on the second cutout 257 in the negative circumference direction about the first axis 201, thereby causing the pivot 220 to pivot from the first phase position 220L toward the third phase position 220N. In this case, the first axial member 271 connected to the pivot 220 leaves out of the first cutout 256 with the pivotal motion of the pivot 220. Thus, a range of motion available to the pivot 220 between the first phase position 220L and the third phase position 220N can be defined beyond a range of motion available to the first axial member 271 on the first cutout 256.

Accordingly, the holding portion 321 for detachably holding the tool T can be caused to rotate in a wider range.

A structure is also assumed in which the pivot 220 is caused to pivot between the first phase position 220L, the second phase position 220M, and the third phase position 220N, using one piston cylinder and a rack pinion mechanism. In such a structure, however, in keeping with the pivotal range of 180 degrees between the second phase position 220M and the third phase position 220N, the stroke volume for the piston cylinder needs be set sufficiently large. This results in an increase in size of the automated conveying apparatus. In the present embodiment, in contrast, since the first actuator 241 for causing the pivot 220 to pivot in an angular extent of 90 degrees between the first phase position 220L and the second phase position 220M and the second actuator 242 for causing the pivot 220 to pivot between the first phase position 220L and the third phase position 220N are disposed around the first axis 201, the automated conveying apparatus 200 is compactly configured.

The direction of slide of the first block 251 (the second direction) between the first position 251A and the second position 251B and the direction of slide of the second block 252 (the third direction) between the third position 252A and the fourth position 252B are the same Y-axis direction. According to such a configuration, since the first actuator 241 for causing the first block 251 to slide and the second actuator 242 for causing the second block 252 to slide are disposed parallel to each other, the automated conveying apparatus 200 is more compactly configured.

Note that, in the present invention, the direction of slide of the first block by the first actuator and the direction of slide of the second block by the second actuator may be non-parallel to each other.

Moreover, the first position 251A and the third position 252A oppose each other in Z-axis direction, and the second position 251B and the fourth position 252B oppose each other in Z-axis direction. According to such a configuration, the first block 251 and the second block 252 are caused to slide in a symmetrical positional relationship, and the automated conveying apparatus 200 is thereby more compactly configured.

Moreover, when the first block 251 is positioned at the first position 251A and the second block 252 is positioned at the third position 252A, the first opening 256j and the second block 252 open to each other in Z-axis direction, and the second opening 257j and the first block 251 open to each other in Z-axis direction. According to such a configuration, the interference between the first axial member 271 and the wall of the first cutout 256 can be readily prevented which occurs when the first axial member 271 leaves out of the first cutout 256 through the first opening 256j, and the interference between the second axial member 272 and the wall of the second cutout 257 can be readily prevented which occurs when the second axial member 272 leaves out of the second cutout 257 through the second opening 257j.

Moreover, the first axial member 271 when the first block 251 is positioned at the first position 251A and the first axial member 271 when the first block 251 is positioned at the second position 251B are arranged co-linearly in Y-axis direction. With such a configuration, the first block 251 having the first cutout 256 can be reduced in size, while expanding the range of pivotal motion of the pivot 220 between the first phase position 220L and the second phase position 220M. Furthermore, the second axial member 272 when the second block 252 is positioned at the third position 252A and the second axial member 272 when the second block 252 is positioned at the fourth position 252B are arranged co-linearly in Y-axis direction. With such a configuration, the second block 252 having the second cutout 257 can be reduced in size, while expanding the range of pivotal motion of the pivot 220 between the first phase position 220L and the third phase position 220N.

Moreover, the second phase position 220M is shifted from the first phase position 220L by 90 degrees in the positive circumference direction about the first axis 201, and the third phase position 220N is shifted from the first phase position 220L by 90 degrees in the negative circumference direction about the first axis 201. According to such a configuration, the holding portion 321 for holding the tool is allowed to rotate between the three postures that are shifted from each other by 90 degrees.

Moreover, the first axial member 271 and the second axial member 272 are cam followers. According to such a configuration, the friction between the first axial member 271 and the first block 251 and the friction between the second axial member 272 and the second block 252 are reduced, thereby allowing smoother pivotal motion of the pivot 220.

Note that the spacing between the first phase position, the second phase position, and the third phase position according to the present invention may have an angle less than 90 degrees or an angle greater than 90 degrees. Moreover, the first axial member and the second axial member according to the present invention are not limited to cam followers, and may be cylindrical pin members, for example. The conveyance objects according to the present invention are not limited to tools, and may be workpieces, for example.

### Embodiment 2

In the present embodiment, a structure of a tool change unit 310 included in an automated conveying apparatus 200 will be described in more detail.

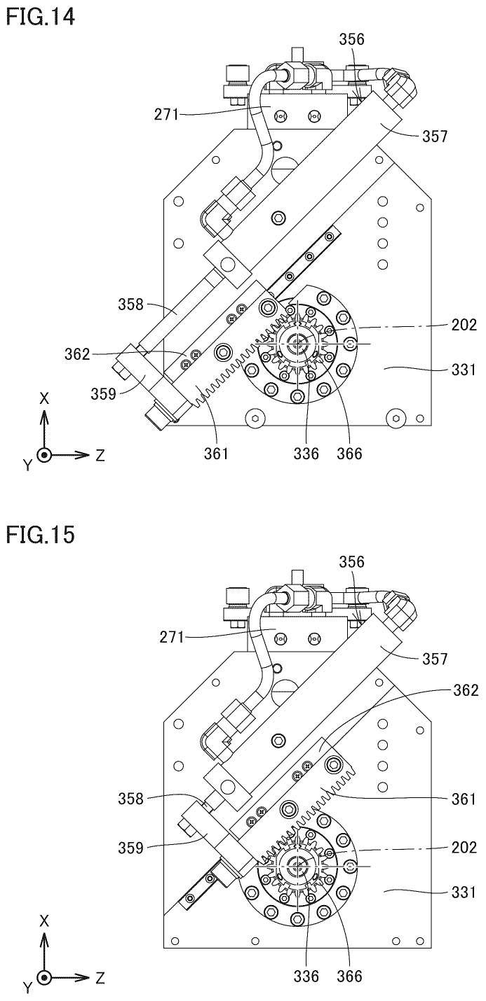

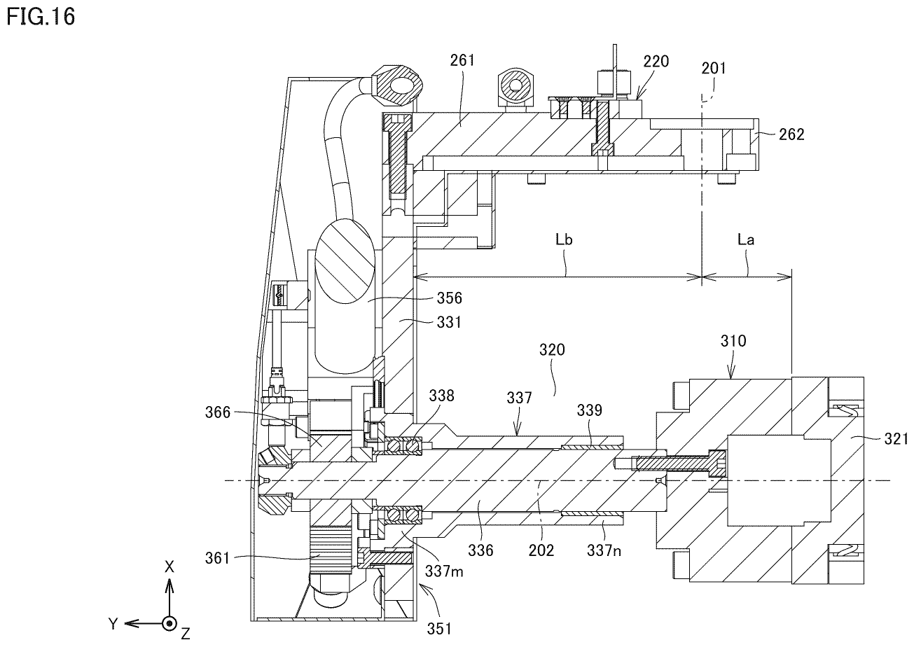

FIG. 14 is a side view showing an aspect of a piston cylinder during the extension motion in the automated conveying apparatus of FIGS. 5 and 6. FIG. 15 is a side view showing an aspect of the piston cylinder during the retraction motion in the automated conveying apparatus of FIGS. 5 and 6. FIG. 16 is a cross-sectional view of the automated conveying apparatus of FIGS. 5 and 6.

Referring to FIGS. 5, 6, and 14 through 16, the automated conveying apparatus 200 (a tool change unit 310) further has a plate 331, a shaft 336, a housing 337, a first bearing 338, and a second bearing 339.

The direction of thickness of the plate 331 is Y-axis direction and the plate 331 has a plate shape disposed in parallel to an X-Z axis plane. The plate 331, as viewed in the axial direction (Y-axis direction) of a turning center axis 202, has a generally rectangular shape having a pair of opposing end sides extending in Z-axis direction and a pair of opposing end sides extending in X-axis direction.

The plate 331 is connected to the pivot 220. The plate 331 is connected to a plate 261. The plate 331 has an upper end connected to a tip end of the plate 261 that is extending radially outward of the first axis 201 from a coupling 262.

The shaft 336 extends along the turning center axis 202. The shaft 336 has a shaft shape about the turning center axis 202. The shaft 336 passes through the plate 331 in Y-axis direction. The shaft 336 projects from the plate 331 in negative Y-axis direction and in positive Y-axis direction. The shaft 336 is disposed away from the pivot 220 (the plate 261) in negative X-axis direction. The shaft 336 passes through the plate 331 at a location closer to the lower end of the plate 331 than the upper end in X-axis direction.

The shaft 336 has, in negative Y-axis direction, a tip end connected to a holding portion 321 (321p, 321q). The holding portion 321 is connected to the shaft 336 more to the negative side of Y axis than the plate 331.

The length of projection of the shaft 336 from the plate 331 on the negative side of Y axis is greater than the length of projection of the shaft 336 from the plate 331 on the positive side of Y axis. The distance between the plate 331 and the holding portion 321 in Y-axis direction is greater than the distance between the plate 331 and the first axis 201 in Y-axis direction.

The housing 337 extends along the turning center axis 202. The housing 337 has a cylindrical shape about the turning center axis 202.

As shown in FIG. 16, the housing 337 has a first end portion 337m and a second end portion 337n. The first end portion 337m corresponds to the end portion of the housing 337 in positive Y-axis direction, and the second end portion 337n corresponds to the end portion of the housing 337 in negative Y-axis direction. The first end portion 337m is connected to the plate 331. The second end portion 337n is located away from the plate 331 in negative Y-axis direction. The shaft 336 is inserted inside the housing 337.

The first bearing 338 and the second bearing 339 support the shaft 336 in a manner that the shaft 336 can rotate about the turning center axis 202. The first bearing 338 and the second bearing 339 are interposed between the shaft 336 and the housing 337. The first bearing 338 is formed of a rolling bearing. The second bearing 339 is formed of a sliding bearing.

The first bearing 338 and the second bearing 339 are disposed apart from each other in the axial direction of the turning center axis 202. The first bearing 338 is provided within the first end portion 337m. The first bearing 338 is arranged between the shaft 336 and the plate 331 in the radial direction of the turning center axis 202. The second bearing 339 is provided within the second end portion 337n.

A space 320 is formed between the plate 331 and the holding portion 321 in the axial direction of the turning center axis 202. A tool (the cutting portion of the tool) held by the holding portion 321 is disposed in the space 320. During the turning motion of the holding portion 321, the cutting portion of the tool held by the holding portion 321 moves in the circumference direction about the turning center axis 202 in the space 320.

The automated conveying apparatus 200 (the tool change unit 310) further has a pinion 366, a rack 361, a piston cylinder 356, and a linear guide 362.

The pinion 366 is disposed in a manner that the pinion 366 and the holding portion 321 (321p, 321q) can rotate together about the turning center axis 202. The pinion 366 is connected to the shaft 336 more to the positive side of Y axis than the plate 331. The shaft 336 connects the holding portion 321 and the pinion 366.

The distance between the plate 331 and the pinion 366 in Y-axis direction is less than the distance between the plate 331 and the holding portion 321 in Y-axis direction.

The rack 361 is engaged with the pinion 366. The rack 361 extends in a second direction, which is orthogonal to a first direction (Y-axis direction) and inclined relative to the horizontal direction (Z-axis direction) and the vertical direction (X-axis direction). The second direction is included in the X-Z axis plane and non-parallel to X-axis direction and Z-axis direction.

The angle formed between the second direction and X-axis direction is 45 degrees. The angle formed between the second direction and Z-axis direction is 45 degrees. The angle formed between the second direction and Z-axis direction may be in a range greater than or equal to 35 degrees and less than or equal to 45 degrees or in a range greater than or equal to 25 degrees and less than or equal to 45 degrees. Alternatively, the angle formed between the second direction and X-axis direction may be in a range greater than or equal to 35 degrees and less than or equal to 45 degrees or in a range greater than or equal to 25 degrees and less than or equal to 45 degrees.

The piston cylinder 356 extends in the second direction parallel to the rack 361. The piston cylinder 356 causes the rack 361 to slide in the second direction.

The rack 361 and the piston cylinder 356 are arranged more to the positive side of Y axis than the plate 331. The rack 361 and the piston cylinder 356 are mounted on the plate 331. The rack 361 is engaged with the pinion 366 from obliquely above on the positive side of X axis and on the negative side of Z axis.

The linear guide 362 is connected to the plate 331. The rack 361 is mounted on the plate 331 via the linear guide 362. The rack 361 is supported by the linear guide 362 in a manner slidable in the second direction.

The piston cylinder 356 is of a hydraulic type. The piston cylinder 356 has a cylinder 357 and a cylinder piston rod 358. The cylinder 357 is connected to the plate 331. The cylinder piston rod 358 is fitted into the cylinder 357. The rack 361 is connected to the cylinder piston rod 358 via a linking block 359. The rack 361 is disposed in parallel to the cylinder piston rod 358 and the cylinder 357. The cylinder piston rod 358 and the rack 361 extend from the linking block 359 in the same direction along the second direction.

As shown in FIG. 15, the cylinder piston rod 358 of the piston cylinder 356 is retracted. The rack 361 linearly moves in one direction along the second direction and the pinion 366 rotates 180 degrees in the positive circumference direction (clockwise of FIG. 15) about the turning center axis 202. As shown in FIG. 14, the cylinder piston rod 358 of the piston cylinder 356 is extended. The rack 361 linearly moves in a reverse direction along the second direction and the pinion 366 rotates 180 degrees in the negative circumference direction (anti-clockwise of FIG. 14) about the turning center axis 202. This allows the holding portion 321 to turn plus or minus 180 degrees about the turning center axis 202 to interchange the positions of the holding portion 321p and the holding portion 321q.

In the present embodiment, the rack 361 and the piston cylinder 356 are arranged obliquely to the horizontal direction and the vertical direction. With such a configuration, the elongated rack 361 and piston cylinder 356 can be prevented from affecting the size of the automated conveying apparatus 200 in the horizontal direction and the vertical direction, resulting in a compactly configured automated conveying apparatus 200.

Moreover, the first bearing 338 is arranged between the shaft 336 and the plate 331 in the radial direction of the turning center axis 202. According to such a configuration, the diameter of the housing 337 can be reduced and a large space 320 can be ensured between the plate 331 and the holding portion 321 in the axial direction of the turning center axis 202, as compared to a structure in which the first bearing 338 is accommodated within the housing 337 between the plate 331 and the holding portion 321. Since the cutting portion of the tool held by the holding portion 321 is disposed in the space 320, limitations on the shape of tools that can be held by the holding portion 321 (shapes of cutting portion) can be reduced.

Moreover, the rack 361 and the piston cylinder 356 are mounted on the plate 331. According to such a configuration, since the plate 331 serves to support the piston cylinder 356 and the rack 361, in addition to serving to support the shaft 336 via the first bearing 338, the automated conveying apparatus 200 can have a simplified structure.

Moreover, the pinion 366, the rack 361, and the piston cylinder 356 are disposed opposite the holding portion 321 across the plate 331. According to such a configuration, an even larger space 320 can be assured between the plate 331 and the holding portion 321 in the axial direction of the turning center axis 202.

The automated conveying apparatus 200 includes the base unit 210 and the pivot 220 that is supported by the base unit 210 in a manner pivotable about the first axis 201. The pivot 220 has the holding portion 321 for detachably holding a tool T as a conveyance object and the turning mechanism 351 which is configured to cause the holding portion 321 to turn about the turning center axis 202 orthogonal to the first axis 201, the holding portion 321 and the turning mechanism 351 opposing each other in the axial direction of the turning center axis 202. The first axis 201 is at a position between the holding portion 321 and the turning mechanism 351 in the axial direction of the turning center axis 202, the position being located closer to the holding portion 321 than the turning mechanism 351.

The turning mechanism 351 includes the plate 331, the pinion 366, the rack 361, the piston cylinder 356, and the linear guide 362. The shaft 336 connects the turning mechanism 351 and the holding portion 321. The turning mechanism 351 and the holding portion 321 oppose each other across the space 320 in the axial direction of the turning center axis 202. As shown in FIG. 16, a distance La between the first axis 201 and the holding portion 321 in the axial direction of the turning center axis 202 is less than a distance Lb between the first axis 201 and the turning mechanism 351 (the plate 331) in the axial direction of the turning center axis 202 (La<Lb).

As shown in FIGS. 2 through 4, the tool T has a shank portion Sh and a cutting portion C. The shank portion Sh is gripped by the holding portion 321 or clamped on the spindle of the machine tool. The specifications of the shank portion Sh are not specifically limited, and the shank portion Sh may be a CAPTO, a BT, or a HSK. The cutting portion C processes a workpiece in contact with the surface of the workpiece. The cutting portion C is connected to the shank portion Sh. The cutting portion C of the tool T held by the holding portion 321 is disposed in the space 320 shown in FIG. 16.

As shown in FIG. 16, the second bearing 339 is arranged between the first axis 201 and the turning mechanism 351 (the plate 331) in the axial direction of the turning center axis 202. The second bearing 339 is arranged closer to the first axis 201 than the turning mechanism 351 (the plate 331) in the axial direction of the turning center axis 202. The distance between the second bearing 339 and the first axis 201 in the axial direction of the turning center axis 202 is less than the distance between the second bearing 339 and the turning mechanism 351 (the plate 331) in the axial direction of the turning center axis 202.

While the embodiment according to the present invention has been described above, the embodiment presently disclosed should be considered in all aspects illustrative and not restrictive. The scope of the present invention is defined by the appended claims. All changes which come within the meaning and range of equivalency of the appended claims are to be embraced within their scope.

What is claimed is:

1. An automated conveying apparatus, comprising:
a base unit; and
a pivot supported by the base unit in a manner rotatable about a first axis, wherein
the pivot has:
a holding portion for detachably holding a conveyance object; and
a turning mechanism configured to cause the holding portion to turn about a turning center axis orthogonal to the first axis, the holding portion and the turning mechanism opposing each other in an axial direction of the turning center axis, wherein
the first axis is located at a position between the holding portion and the turning mechanism in the axial direction of the turning center axis, the position being closer to the holding portion than the turning mechanism.
